(19) United States
(12) Patent Application Publication
(10) Pub. No.: US 2014/0070562 A1
(43) Pub. Date: Mar. 13, 2014

(54) AUTOMOBILE BODY UNDERCOVER

(71) Applicant: Yuichiro Inagaki, Kasugai-shi (JP)

(72) Inventor: Yuichiro Inagaki, Kasugai-shi (JP)

(73) Assignee: HOWA TEXTILE INDUSTRY CO., LTD, Aichi-ken (JP)

(21) Appl. No.: 13/821,211

(22) PCT Filed: Feb. 16, 2012
(86) PCT No.: PCT/JP12/53630

§ 371 Date: Apr. 2, 2013

(30) Foreign Application Priority Data
May 30, 2011 (JP) 2011-120571

(51) Int. Cl. B62D 25/20; B62D 35/02

(52) U.S. Cl. CPC B62D 25/2072; B62D 35/02
USPC 296/180.1

(57) ABSTRACT

Disclosed is an automobile body undercover having durability against damage from foreign objects such as flying stones even in a case where a nonwoven fabric is used on an outer surface on a road surface side in order to achieve sound absorbing characteristics with respect to engine noise leaked outside a car, road noise originating from the road surface side, or the like. The automobile body undercover includes at least: a base material layer (11) that includes a mixture of a fiber reinforcing material and a first thermoplastic synthetic resin (13); and a nonwoven fabric layer (15) of a thermoplastic synthetic fiber that is stacked on a surface that is a road surface side of the base material layer (11), surface portions of both the layers being bonded by thermal fusion, and both the layers being compression-molded into a predetermined shape to form a fiber molded body, wherein the first thermoplastic synthetic resin (13) of the base material layer (11) has a melting point for melting in a heating process at the time of molding, and wherein the nonwoven fabric layer (15) includes a mixture of a second thermoplastic synthetic fiber (16) having a melting point for melting in the heating process at the time of molding and a third thermoplastic synthetic fiber (17) having a melting point for non-melting in the heating process at the time of molding.

### FIELD OF THE DISCLOSURE

The present disclosure relates to an automobile body undercover.

### BACKGROUND ART

In recent years, a body undercover that covers a lower surface side of an automobile is mounted to a lower portion of the automobile in order to suppress air resistance of air flow that passes under the lower portion of the automobile (refer to JP-UM-A-59-129676). The body undercover is provided to improve the flow of air flow that passes under a lower surface of a car body to suppress an air resistance value, thereby enhancing fuel efficiency. Further, the effects of driving stability, steering stability and protection of car body components from damage from foreign objects such as flying stones during driving are also achieved.

As the automobile body undercover that covers the lower surface side of the automobile for fuel efficiency enhancement, driving stability and steering stability due to such aerodynamic characteristics, a resin material using olefin as a main component has been used. JP-A-5-24559 discloses a technique of an engine undercover that uses a thermoplastic resin such as polypropylene, as an example of the automobile body undercover.

However, the automobile body undercover made of the resin material using olefin as the main component has a problem of being a heavy weight. For this reason, in order to reduce the weight, an automobile body undercover using, as a base material, a fibrous plate material in which a glass fiber is used as a reinforcing material has been developed. According to such an automobile body undercover, sound absorbing characteristics are enhanced by a configuration of minute holes between fibers. In this regard, there is an example of an automobile body undercover in which a resin reinforcing layer is provided on an outer surface thereof on a road surface side in order to prevent damage of original functions such as durability against flying stones, suppression of coating of ice and snow or smoothness necessary for the automobile body undercover (refer to JP-A-2009-298340).

However, the resin reinforcing layer blocks air permeability, which causes a problem that it is difficult to efficiently achieve sound absorbing characteristics with respect to road noise originating from the road surface side. On the other hand, in order to achieve the sound absorbing characteristics on the road surface side, a configuration may be considered in which a nonwoven fabric made of a synthetic resin having air permeability is provided on the outer surface on the road surface side. However, there is a possibility that the absence of durability against flying stones due to fuzzing of the nonwoven fabric causes a problem to damage the original functions of the automobile body undercover.

Accordingly, there has been a need for improved automobile body undercovers having durability against damage from foreign objects such as flying stones even in a case where the nonwoven fabric is used on the outer surface thereof on the road surface side in order to achieve the sound absorbing characteristics with respect to engine noise that is leaked outside the car, road noise originating from the road surface side, or the like.

### BRIEF SUMMARY

As for a first aspect of the present disclosure, an automobile body undercover is provided on a lower surface of a car body. The automobile body undercover includes at least: a base material layer that includes a mixture of a fiber reinforcing material and a first thermoplastic synthetic resin; and a nonwoven fabric layer of a thermoplastic synthetic fiber that is stacked on a surface that is a road surface side of the base material layer, surface portions of both the layers being bonded by thermal fusion, and both the layers being compression-molded into a predetermined shape to form a fiber molded body. The first thermoplastic synthetic resin of the base material layer has a melting point for melting in a heating process at the time of molding. The nonwoven fabric layer includes a mixture of a second thermoplastic synthetic fiber having a melting point for melting in the heating process at the time of molding and a third thermoplastic synthetic fiber having a melting point for non-melting in the heating process at the time of molding.

According to the above configuration, the first thermoplastic synthetic resin of the base material layer and the second thermoplastic synthetic fiber of the nonwoven fabric layer are melted in the heating process at the time of molding, and the fiber reinforcing material of the base material layer and the third thermoplastic synthetic fiber of the nonwoven fabric layer are bonded by thermal fusion to form the fiber molded body. Accordingly, it is possible to achieve an automobile body undercover of a light weight. The third thermoplastic synthetic fiber of the nonwoven fabric layer disposed on the road surface side is not melted in the heating process at the time of molding, and thus remains even though the second thermoplastic synthetic fiber is melted. The melted second thermoplastic synthetic fiber is impregnated and fixed in the third thermoplastic synthetic fiber to form a reinforcing layer having minute holes between fibers. The sound absorbing characteristics are achieved by a configuration of the minute holes between fibers. Further, fuzzing of the surface is prevented, and a smooth surface is achieved. Thus, durability against damage from foreign objects such as flying stones is achieved. Hence, it is possible to provide an automobile body undercover having durability against damage from foreign objects such as flying stones even in a case where the nonwoven fabric is used on the outer surface on the road surface side in order to achieve the sound absorbing characteristics with respect to engine noise leaked outside the car, road noise originating from the road surface side, or the like.

As for a second aspect of the present disclosure, in the automobile body undercover according to the first aspect of the present disclosure, the first thermoplastic synthetic resin and the second thermoplastic synthetic fiber are thermoplastic synthetic fibers having the same quality.

According to the above configuration, as the first thermoplastic synthetic resin and the second thermoplastic synthetic fiber include materials having the same quality, it is possible to effectively perform the thermal fusion bonding of the base material layer and the nonwoven fabric layer. Further, it is possible to suppress separation of the base material layer and the nonwoven fabric layer.

According to the above-described configurations, it is possible to provide an automobile body undercover having durability against damage from foreign objects such as flying stones even in a case where the nonwoven fabric is used on the outer surface on the road surface side in order to achieve the sound absorbing characteristics with respect to engine noise leaked outside the car, road noise originating from the road surface side, or the like.

### BRIEF DESCRIPTION OF DRAWINGS

FIG. 1 is a cross-sectional view schematically illustrating a state where a base material layer and a nonwoven fabric layer of an automobile body undercover according to an embodiment of the present disclosure are stacked.

FIG. 2A is a cross-sectional view illustrating a heating and pressurizing process in a heating platen press in a manufacturing process of an automobile body undercover according to an embodiment of the present disclosure, FIG. 2B is a cross-sectional view illustrating a cold pressing process in a cold press in the same manufacturing process, FIG. 2C is a cross-sectional view illustrating a process of cutting an extra part of an outer circumference of a stacked body by an extra part cutting unit in cold press molding in the same manufacturing process, and FIG. 2D is a cross-sectional view illustrating a molded product 34 of an automobile body undercover in the same manufacturing process.

FIG. 3 is a perspective view illustrating an automobile body undercover according to an embodiment of the present disclosure.

FIG. 4 is a cross-sectional view schematically illustrating a state where an automobile body undercover according to an embodiment of the present disclosure is mounted to an automobile.

FIG. 5 is a diagram illustrating sound absorbing characteristics of an automobile body undercover according to an embodiment of the present disclosure.

### DESCRIPTION OF EMBODIMENTS

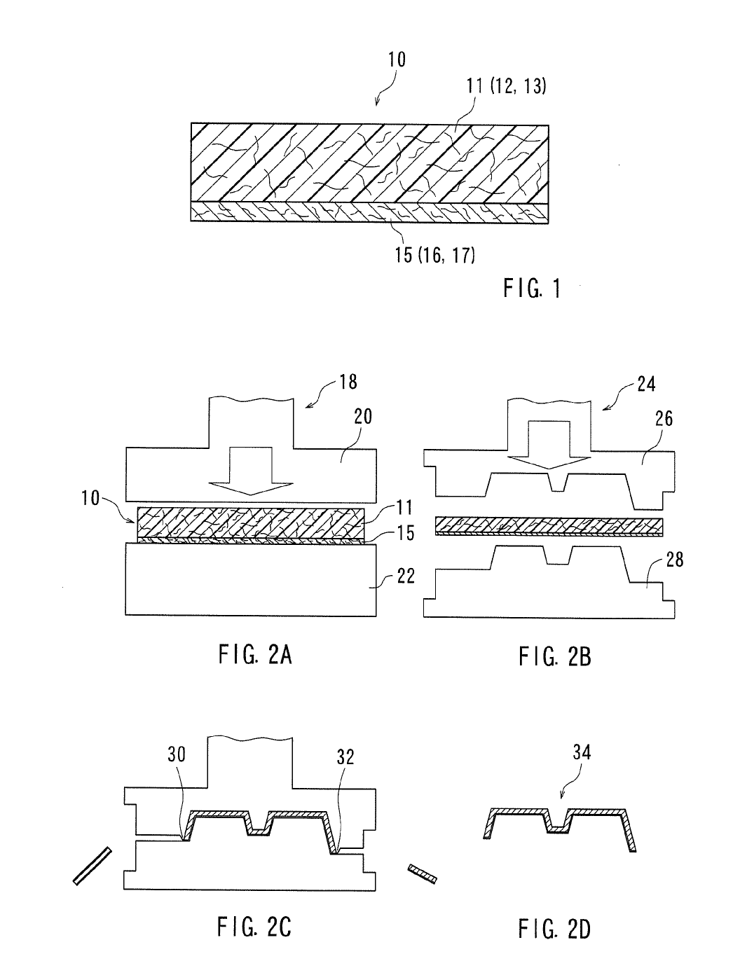

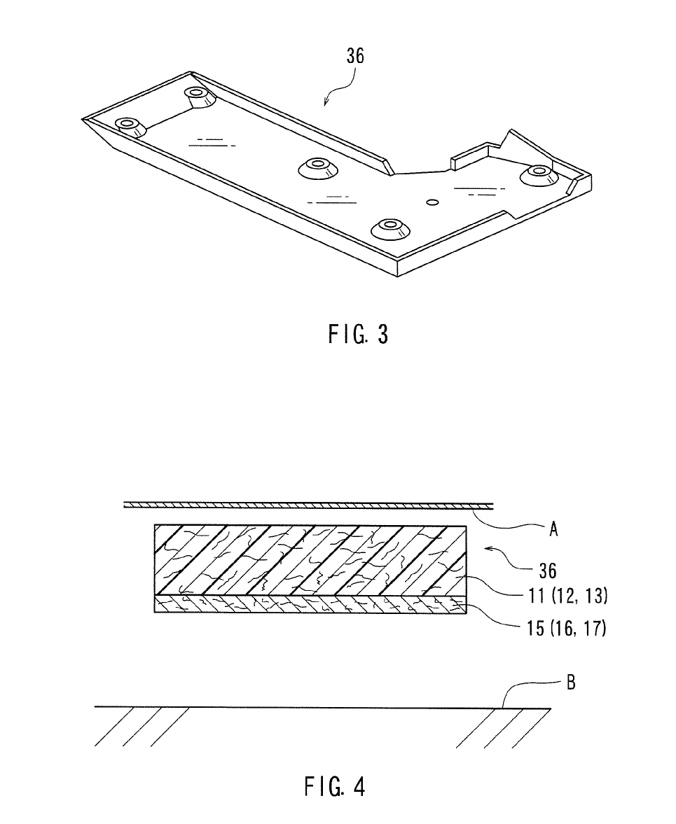

Hereinafter, embodiments of the present disclosure will be described with reference to FIGS. 1 to 5. As shown in FIGS. 1 and 3, an automobile body undercover 36 according to the present embodiment is a fiber molded body obtained by stacking a base material layer 11 and a nonwoven fabric layer 15. As shown in FIG. 4, in the automobile body undercover 36, the base material layer 11 is disposed on the side of a car body A and the nonwoven fabric layer 15 is disposed on the side of a road surface B. The base material layer 11 includes a fiber reinforcing material 12 and a first thermoplastic synthetic resin 13. The nonwoven fabric layer 15 includes a second thermoplastic synthetic fiber 16 and a third thermoplastic synthetic fiber 17.

<Base Material Layer 11>

The base material layer 11 is a fiber mat that includes the fiber reinforcing material 12 and the first thermoplastic synthetic resin 13. The base material layer 11 may be formed by selecting either method of a dry method represented as cross laying or air laying or a wet method represented as paper making.

In a case where the dry method (cross laying) is used, the base material layer 11 is obtained by cutting a fiber body of the fiber reinforcing material 12 and the first thermoplastic synthetic resin 13 into a predetermined fiber length, by sufficiently mixing the cut fiber body by an opener (mixing), and by laminating the result by a carding machine to form a fibrous web of a predetermined weight. Then, the fibrous web is needle-punched to confound fibers of a fiber body of the fiber reinforcing material 12 and the first thermoplastic synthetic resin 13, to thereby form a fiber mat.

In a case where the dry method (air laying) is used, the base material layer 11 is obtained by cutting the fiber body of the fiber reinforcing material 12 and the first thermoplastic synthetic resin 13 into a predetermined fiber length, by sufficiently mixing the cut fiber body by air flow referred to as air lay (mixing), and by laminating the result to form a fibrous web of a predetermined weight. The fibrous web is needle-punched to confound fibers of the fiber body of the fiber reinforcing material 12 and the first thermoplastic synthetic resin 13, to thereby form the fiber mat. As the first thermoplastic synthetic resin 13 in the dry method, a thermoplastic synthetic fiber is selected.

In a case where the wet method is used, the base material layer 11 is obtained by dispersing the fiber reinforcing material 12 and the first thermoplastic synthetic resin 13 in water, by floating the result by a reticular net or the like to form fleeces, and by drying the fleeces by a heater to form a fiber mat. As the first thermoplastic synthetic resin 13 in the wet method, a power of a thermoplastic synthetic resin is used.

A glass fiber that is a non-organic fiber such as a chopped strand, a natural fiber that is an organic fiber, such as jute, kenaf, ramie, hemp, sisal hemp or bamboo is appropriately selected as the fiber reinforcing material 12.

In a case where the dry method (cross laying and air laying) is used, the length of the fiber reinforcing material 12 is in the range of 20 to 100 mm. In a case where the fiber reinforcing material 12 is shorter than 20 mm, it is difficult to obtain effective bending stiffness due to the fiber reinforcing material 12. Further, entanglement of the fiber reinforcing material 12 and the first thermoplastic synthetic resin 13 becomes weak. In a case where the fiber reinforcing material 12 is longer than 100 mm, it is difficult to perform mixing, and thus, it is difficult to uniformly mix the fiber reinforcing material 12 with the first thermoplastic synthetic resin 13 with respect to a unit area. Thus, it is difficult to obtain uniform bending strength and shock resistance. Further, it is difficult to perform the needle punch confounding. The diameter of the fiber reinforcing material 12 is in the range of 5 to 50 μm.

In a case where the wet method (paper making) is used, the length of the fiber reinforcing material 12 is in the range of 5 to 20 mm. The reason why the length is short compared with the dry method is to uniformly disperse the fiber reinforcing material 12 in water.

In a case where the dry method (cross laying and air laying) is used, a polyethylene fiber, a polypropylene fiber or the like is selected as the first thermoplastic synthetic resin 13. A softening point of the polyethylene fiber is 100° C. to 115° C., and a melting point thereof is 125° C. to 135° C. A softening point of the polypropylene fiber is 140° C. to 160° C., and a melting point thereof is 165° C. to 173° C. Since the first thermoplastic synthetic resin 13 is melted in a heating process at the time of molding to be described later, the length and the diameter of the fiber are not limited as long as they are in a range where the first thermoplastic synthetic resin 13 can be uniformly mixed with the fiber reinforcing material 12 to form a fiber mat in the needle punching.

In a case where the wet method (paper making) is used, powder made of polyethylene, polypropylene or the like is selected as the first thermoplastic synthetic resin 13. Softening points and melting points of the polyethylene and polypropylene are the same as the above description.

The total weight of the base material layer 11 is set in the range of 500 to 2000 g/m². A lower limit value of the total weight of the base material layer 11 is 500 g/m², preferably 700 g/m² or more, and more preferably 1000 g/m² or more. If the total weight of the base material layer 11 is lower than the lower limit value, bending stiffness and shock resistance deteriorate. An upper limit value of the total weight of the base material layer 11 is 2000 g/m² or less, preferably 1500 g/m² or less, and more preferably 1400 g/m² or less. If the total weight of the base material layer 11 is higher than the upper limit value, the volume of the base material layer 11 increases and the fibers cannot be favorably confounded in the needle punching. Further, since the weight increases, it is difficult to achieve a light weight. In the range of such a weight, the weight of the base material layer 11 that is finally obtained is appropriately set according to a required value as the automobile body undercover 36 of each car type.

Here, with respect to the total weight of 500 to 2000 g/m² of the base material layer 11, the weight of the fiber reinforcing material 12 is 30 to 60% by weight. If the weight is smaller than 30% by weight, bending stiffness and shock resistance deteriorate. If the weight is larger than 60% by weight, the amount of the first thermoplastic synthetic resin 13 becomes small in the total amount, which causes reduction in adhesive bonding strength to the nonwoven fabric layer 15 to be described later.

<Nonwoven Fabric Layer 15>

The nonwoven fabric layer 15 is a fiber mat that includes the second thermoplastic synthetic fiber 16 and the third thermoplastic synthetic fiber 17. As the second thermoplastic synthetic fiber 16, a material that is melted at a heating temperature in processing the automobile body undercover 36 is selected. As the third thermoplastic synthetic fiber 17, a material that is not melted at the heating temperature in processing is selected. The second thermoplastic synthetic fiber 16 forms a reinforcing layer in a state where the second thermoplastic synthetic fiber 16 is melted at the heating temperature in processing and is impregnated and fixed in the third thermoplastic synthetic fiber 17 to open minute holes. The heating temperature in processing is determined by the melting temperature of the first thermoplastic synthetic resin 13 of the base material layer 11. The third thermoplastic synthetic fiber 17 has a melting point (preferably, a softening point) higher than the melting temperature of the first thermoplastic synthetic resin 13 of the base material layer 11. It is preferable that the same material as that of the first thermoplastic synthetic resin 13 of the base material layer 11 is selected for the second thermoplastic synthetic fiber 16, in consideration of effective thermal fusion bonding of the base material layer 11 and the nonwoven fabric layer 15.

A polyethylene fiber, a polypropylene fiber or the like is selected as the second thermoplastic synthetic fiber 16. A softening point of the polyethylene fiber is 100° C. to 115° C., and a melting point thereof is 125° C. to 135° C. A softening point of the polypropylene fiber is 140° C. to 160° C., and a melting point thereof is 165° C. to 173° C. It is preferable that the second thermoplastic synthetic fiber 16 has the same material as that of the first thermoplastic synthetic resin 13. This is to effectively achieve the thermal fusion bonding of the base material layer 11 and the nonwoven fabric layer 15 so that the base material layer 11 and the nonwoven fabric layer 15 are hardly separated from each other.

The fiber length of the second thermoplastic synthetic fiber 16 is in the range of 20 to 100 mm. In a case where the second thermoplastic synthetic fiber 16 is shorter than 20 mm, entanglement with the third thermoplastic synthetic fiber 17 becomes weak. On the other hand, in a case where the second thermoplastic synthetic fiber 16 is longer than 100 mm, mixing with the third thermoplastic synthetic fiber 17 becomes difficult, it is difficult to uniformly mix both fabrics with respect to a unit area, and thus, it is difficult to obtain uniform bending strength and shock resistance.

Since the second thermoplastic synthetic resin 16 is melted in the heating process at the time of molding to be described later, the diameter of the fiber is not limited as long as it is in a range where the second thermoplastic synthetic resin 16 can be uniformly mixed with the third thermoplastic synthetic fiber 17 to form a fiber mat in the needle punching.

The third thermoplastic synthetic fiber 17 has a thermoplastic synthetic fiber material having a melting point (preferably, a softening point) of about 200° C. or higher. A polyethylene terephthalate fiber, a polyester fiber or the like is selected. A softening point of the polyethylene terephthalate fiber is 238° C. to 240° C., and a melting point thereof is 255° C. to 260° C. A softening point of the polyester fiber is 238° C. to 240° C., and a melting point thereof is 255° C. to 260° C.

The fiber length of the third thermoplastic synthetic fiber 17 is in the range of 20 to 100 mm. In a case where the third thermoplastic synthetic fiber 17 is shorter than 20 mm, entanglement with the second thermoplastic synthetic fiber 16 becomes weak. On the other hand, in a case where the third thermoplastic synthetic fiber 17 is longer than 100 mm, mixing with the second thermoplastic synthetic fiber 16 becomes difficult, and thus, it is difficult to uniformly mix both fabrics with respect to a unit area.

The diameter of the third thermoplastic synthetic fiber 17 is in the range of 2 to 15 dtex. If the diameter is smaller than 2 dtex, the stitch of the third thermoplastic synthetic fiber 17 becomes small, which causes reduction in a sound absorption coefficient.

If the diameter is larger than 15 dtex, the stitch of the third thermoplastic synthetic fiber 17 becomes large to increase the level of air permeability, which deteriorates surface smoothness. Thus, durability against flying stones or the like may decrease. More preferably, the diameter is in the range of 3 to 11 dtex.

The total weight of the nonwoven fabric layer 15 is set in the range of 50 to 400 g/m². A lower limit value of the total weight of the nonwoven fabric layer 15 is 50 g/m², preferably 80 g/m² or more, and more preferably 100 g/m² or more. If the total weight of the nonwoven fabric layer 15 is lower than the lower limit value, the nonwoven fabric layer 15 is thin. Thus, a part of the surface is damaged, and thus, ice and snow are easily coated thereon. Further, bending stiffness and shock resistance deteriorate and durability against flying stones or the like is reduced. An upper limit value of the total weight of the nonwoven fabric layer 15 is 400 g/m² or less, preferably 230 g/m² or less, and more preferably 200 g/m² or less. If the total weight of the nonwoven fabric layer 15 is higher than the upper limit value, the weight becomes large, and thus, it is difficult to achieve a light weight. In the above-described range of the total weight of the nonwoven fabric layer 15, the weight that is finally obtained is appropriately set according to a required value as the automobile body undercover 36 of each car type. The nonwoven fabric layer 15 is manufactured by the dry method (cross laying and air laying) that is the same manufacturing method as that of the base material layer 11.

Here, with respect to the total weight of 50 to 400 g/m² of the nonwoven fabric layer 15, the weight of the third thermoplastic synthetic fiber 17 is 30 to 50% by weight. If the weight of the third thermoplastic synthetic fiber 17 is smaller than 30% by weight, the second thermoplastic synthetic fiber 16 to be melted becomes large in amount, meshes between fibers of the third thermoplastic synthetic fiber 17 is blocked, and thus, the sound absorbing characteristics deteriorate. If the weight of the third thermoplastic synthetic fiber 17 is larger than 50% by weight, fuzzing of the third thermoplastic synthetic fiber 17 is noticeable, and durability against flying stones or the like decreases.

<Manufacturing Process of Automobile Body Undercover 36>

Next, a manufacturing method of the automobile body undercover 36 according to the present disclosure will be described with reference to FIGS. 1 to 4. The automobile body undercover 36 of the present disclosure is manufactured by the following configurations.

(1) A configuration in which at least the stacked body 10 obtained by stacking the base material layer 11 that includes a mixture of the fiber reinforcing material 12 and the first thermoplastic synthetic resin 13, and the nonwoven fabric layer 15 that includes the second thermoplastic synthetic fiber 16 and the third thermoplastic synthetic fiber 17 on the surface of the base material layer 11 on the side of the road surface B is provided.

(2) A configuration in which surface portions of both layers are bonded by thermal fusion in a state where the base material layer 11 and the nonwoven fabric layer 15 are stacked, the bonded layers are molded into a predetermined shape by compression molding to form a fiber molded body.

(3) A configuration in which the first thermoplastic synthetic resin 13 of the base material layer 11 has a melting point for melting in the heating process at the time of molding.

(4) A configuration in which the nonwoven fabric layer 15 is obtained by mixing the second thermoplastic synthetic fiber 16 having a melting point for melting in the heating process at the time of molding and the third thermoplastic synthetic fiber 17 having a melting point for non-melting in the heating process at the time of molding.

An example of the manufacturing process of the automobile body undercover 36 will be described. In the manufacturing process of the automobile body undercover 36, a fiber molded body in a predetermined shape is formed by a first process of using the heating platen press 18 in a state where the base material layer 11 and the nonwoven fabric layer 15 are stacked and a second process of performing cooling, compression and molding by means of the cold press 24.

As shown in FIG. 2A, in the first process, the stacked body 10 of the base material layer 11 and the nonwoven fabric layer 15 is heated and pressurized in the heating platen press 18, the first thermoplastic synthetic resin 13 of the base material layer 11 is melted to be entangled with the fiber reinforcing material 12 for thermal fusion bonding, and the second thermoplastic synthetic fiber 16 of the nonwoven fabric layer 15 is melted to combine both surface portions of the base material body 11 and the nonwoven fabric layer 15 by thermal fusion bonding.

The stacked body 10 in which the base material layer 11 and the nonwoven fabric layer 15 are stacked is put between an upper platen 20 and a lower platen 22 of the heating platen press 18 that is heated up to a predetermined temperature, and is heated and pressurized for compression molding. The first thermoplastic synthetic resin 13 of the base material layer 11 is melted to be entangled with the fiber reinforcing material 12 for thermal fusion bonding. The second thermoplastic synthetic fiber 16 of the nonwoven fabric layer 15 is melted to be entangled with the third melted thermoplastic synthetic fiber 17 for thermal fusion bonding. Respective surfaces of the first thermoplastic synthetic resin 13 of the base material layer 11 and the second thermoplastic synthetic fiber 16 of the nonwoven fabric layer 15 are bonded by thermal fusion.

The lower limit value of the heating temperature of the heating platen press 18 is set to 180° C. or higher that is higher than the melting point of the first thermoplastic synthetic resin 13. The upper limit value of the heating temperature of the heating platen press 18 is set to 230° C. or lower that is lower than the softening point of the third thermoplastic synthetic fiber 17. Preferably, the upper limit value is set to 190° C. to 210° C.

As shown in FIG. 2B, in the second process, the stacked body 10 of the base material layer 11 and the nonwoven fabric layer 15 that are bonded by thermal fusion is cooled, compressed and molded in the cold press 24 to form a fiber molded body having a predetermined shape. The stacked body 10 of the base material layer 11 and the nonwoven fabric layer 15 that are bonded by thermal fusion is transported to the cold press 24 in the state of being heated. Cooling water is circulated in a die of the cold press 24. The stacked body 10 is cooled and at the same time, is pressurized to be compression-molded, and is molded in a state where the first thermoplastic synthetic resin 13 of the base material layer 11 and the second thermoplastic synthetic fiber 16 of the nonwoven fabric layer 15 are plastically deformed.

The second process is carried out such that the thickness of the final plate is in the range of 1.0 to 10.0 mm. The thickness of the final plate of the automobile body undercover 36 may be uniformly the same, or may be partially different.

For example, according to an arrangement location of the automobile body undercover 36, there may be a portion that is easily in touch with flying stones or the like. In such a case, the plate may be molded to have a thickness decreased into a high density where the plate thickness is partially set to 1.0 to 2.5 mm according to the shape of the die, to thereby improve shock resistance. On the other hand, in order to improve the sound absorption coefficient, the plate may be molded into a low density where the plate thickness is set to 5.0 to 10.0 mm.

The stacked body 10 that is bonded by thermal fusion is extracted from the heating platen press 18 and is transported to the cold press 24. Cooling water is circulated in an upper die 26 and a lower die 28 of the cold press 24 to effectively cool the stacked body 10. The stacked body 10 transported from the heating platen press 18 is set between the upper die 26 and the lower die 28 of the cold press 24, is compressed, pressurized, and crushed up to the final plate thickness, and is cooled.

As shown in FIG. 2C, at the time of molding in the cold press 24, extra parts of outer circumferences of the stacked body 10 are cut by extra part cutting units 30 and 32. Further, hole machining is simultaneously performed in the die. Here, an example in which the removal of extra parts of the outer circumferences of the stacked body 10 and the hole machining are performed at the same time with the molding has been described. However, this is not limitative. That is, in a post-process, the extra part may be cut by a trimming press or a water knife. Further, in the post-process, the hole machining may be performed.

As shown in FIG. 2D, the molded product 34 of the automobile body undercover 36 is finally obtained. Hole machining and component installation that cannot be performed in the die are performed according to the request of the product, to thereby obtain a finished product of the automobile body undercover 36. As shown in FIG. 3, the automobile body undercover 36 is an example thereof.

Further, in the manufacturing method, in the first process, the stacked body 10 of the base material layer 11 and the nonwoven fabric layer 15 is heated and pressurized in the heating platen press 18, the first thermoplastic synthetic resin 13 of the base material layer 11 is melted to be entangled with the fiber reinforcing material 12 for thermal fusion bonding, and the second thermoplastic synthetic fiber 16 of the nonwoven fabric layer 15 is melted to combine both surface portions of the base material body 11 and the nonwoven fabric layer 15 by thermal fusion bonding. In the second process, the stacked body 10 of the base material layer 11 and the nonwoven fabric layer 15 that are bonded by thermal fusion is cooled, compressed, and molded in the cold press 24 to form a fiber molded body having a predetermined shape. In this way, in the manufacturing method, an example in which the first process and the second process are continuously performed has been described.

However, this is not limitative, and the first process and the second process may be intermittently performed. That is, after the first process is performed, cooling and compression are performed in a separate cooling press or roll, to form a planar plate member. Further, when the second process is performed, the plate member is re-heated up to a temperature at which the first thermoplastic synthetic resin and the second thermoplastic synthetic fiber are melted by a non-contact heater such as a far-infrared-ray heater. Further, a manufacturing method of cooling, compressing and molding the plate member by the cold press 24 to obtain a fiber molded body having a predetermined shape of the automobile body undercover may be used.

<Sound Absorption Coefficient>

The automobile body undercover 36 according to the present disclosure generally has the following absorbing coefficient with the above-described configuration. The sound absorption coefficient is based on the JIS A 1409 standard, and is a numerical value measured by a reverberant sound absorption coefficient. Specifically, in order to simulate a car-mounted state, using a flat plate of 5.0 mm, the measurement was performed under the condition of a background air layer of 20 mm.

A sound absorption coefficient of at least 30% was measured at a frequency band of 400 to 6300 Hz.

A sound absorption coefficient of at least 40% was measured in a frequency band of 630 to 6300 Hz.

A sound absorption coefficient of at least 60% was measured in a frequency band of 1000 to 5000 Hz.

A sound absorption coefficient of at least 70% was measured in a frequency band of 1250 to 4000 Hz.

A sound absorption coefficient of at least 75% was measured in a frequency band of 1600 to 3150 Hz.

A sound absorption coefficient of at least 80% was measured in a frequency band of 2000 to 3150 Hz.

<Durability (Chipping Resistance)>

With respect to abrasion of the nonwoven fabric layer 15 of the automobile body undercover 36 due to flying stones or road surface interference in the present disclosure, the following characteristics are obtained.

With respect to the abrasion of the nonwoven fabric layer 15 due to the flying stones or road surface interference, weight loss due to friction was measured under the condition of 9.81 N and 500 times using an H-18 abrasion wheel by a Taber-type abrasion tester according to the JIS L 1096.8.19 standard, in the flat plate of 5.0 mm. Under such a condition, there is a characteristic in which the amount of abrasion loss is less than 0.12 g.

As described above, the automobile body undercover 36 of the present disclosure is formed as the fiber molded body in which the first thermoplastic synthetic resin 13 of the base material layer 11 and the second thermoplastic synthetic fiber 16 of the nonwoven fabric layer 15 are melted in the heating process at the time of molding and the fiber reinforcing material 12 of the base material layer 11 and the third thermoplastic synthetic fiber 17 of the nonwoven fabric layer 15 are bonded by thermal fusion. Thus, it is possible to obtain the automobile body undercover 36 of a light weight. The third thermoplastic synthetic fiber 17 of the nonwoven fabric layer 15 disposed on the side of the road surface B remains even though the second thermoplastic synthetic fiber 16 is melted, since the third thermoplastic synthetic fiber 17 is the fiber body that is not melted in the heating process at the time of molding. The second melted thermoplastic synthetic fiber 16 is impregnated and fixed in the third thermoplastic synthetic fiber 17 to form a reinforcing layer having minute holes between fibers. With such a configuration having minute holes between fibers, it is possible to achieve the sound absorbing characteristics of the base material layer that is porous. Further, since surface fuzzing is prevented to form a smooth surface, durability against damage from foreign objects such as flying stones is achieved. Hence, even in a case where the nonwoven fabric is used on an outer surface on the side of the road B in order to achieve the sound absorbing characteristics with respect to engine sound leaked outside the car, road noise originating from the side of the road B, or the like, it is possible to provide the automobile body undercover 36 that suppress coating of ice and snow and has durability against damage from foreign objects such as flying stones.

By using the same material in the first thermoplastic synthetic resin 13 and the second thermoplastic synthetic fiber 16, it is possible to effectively achieve thermal fusion bonding of the base material layer 11 and the nonwoven fabric layer 15. Further, it is possible to suppress separation of the base material layer 11 and the nonwoven fabric layer 15.

### EXAMPLES

Hereinafter, the present disclosure will be specifically described using Examples and Comparative Examples.

### Example 1

(1) Base Material Layer 11

(a) A glass fiber (average fiber length of 75 mm (3 inches), average diameter of 10 and weight of 600 g/m²) was selected as the fiber reinforcing material 12.

(b) A polypropylene fiber (average fiber length of 64 mm (2.5 inches), average diameter of 6.6 dtex, and weight of 600 g/m²) was selected as the first thermoplastic synthetic resin 13.

(c) The total weight was set to 1200 g/m².

(d) The glass fiber (fiber reinforcing material 12) and the polypropylene fiber (first thermoplastic synthetic resin 13) were web-formed by a mixer and were needle-punched to obtain the base material layer 11. A product made by Nihon Glass Fiber Industrial Co., Ltd. was selected as the base material layer in Example 1.

(2) Nonwoven Fabric Layer 15

(a) A polypropylene fiber (average fiber length of 64 mm (2.5 inches), average diameter of 6.6 dtex, and weight of 100 g/m²) was selected as the second thermoplastic synthetic fiber 16.

(b) A polyethylene terephthalate fiber (average fiber length of 64 mm (2.5 inches), average diameter of 3.3 dtex, and weight of 50 g/m²) was selected as the third thermoplastic synthetic fiber 17.

(c) In the blending quantity of the polypropylene fiber (the second thermoplastic synthetic fiber 16) and the polyethylene terephthalate fiber (the third thermoplastic synthetic fiber 17), the second thermoplastic synthetic fiber 16 was 67% by weight (weight of 100 g/m²), and the third thermoplastic synthetic fiber 17 was 33% by weight (weight of 50 g/m²). That is, the total weight was set to 150 g/m².

(d) The polypropylene fiber (the second thermoplastic synthetic fiber 16) and the polyethylene terephthalate fiber (the third thermoplastic synthetic fiber 17) were web-formed by a mixer and were needle-punched to obtain the nonwoven fabric layer 15. A product made by UNIX Co., Ltd. was selected as the nonwoven fabric layer in Example 1.

(3) The stacked body 10 obtained by stacking the base material layer 11 and the nonwoven fabric layer 15 was put in the heating platen press 18 heated up to a temperature of 190 to 210° C., and was pressurized, heated and compressed. The stacked body 10 had a thickness of about 10.0 mm in a state where the polypropylene fiber of the base material layer 11 and the nonwoven fabric layer 15 were melted at the temperature of about 200° C. The stacked body 10 heated by the heating platen press 18 was pressurized by the cold press 24 and was compressed and molded into a final plate thickness of 1.5 to 5.0 mm, and was cooled at the same time. In Example 1, the automobile body undercover 36 having a plate thickness of 1.5 to 5.0 mm and a weight of 1350 g/m² was obtained.

### Example 2

(1) Base Material Layer 11

The same configuration as in Example 1 was selected as the base material layer 11.

(2) Nonwoven Fabric Layer 15

(a) The same polypropylene fiber as in Example 1 was selected as the second thermoplastic synthetic fiber 16.

(b) A polyethylene terephthalate fiber (average fiber length of 64 mm (2.5 inches), average diameter of 11 dtex, and weight of 150 g/m²) was selected as the third thermoplastic synthetic fiber 17.

(c) In the blending quantity of the polypropylene fiber (the second thermoplastic synthetic fiber 16) and the polyethylene terephthalate fiber (the third thermoplastic synthetic fiber 17), the second thermoplastic synthetic fiber 16 was 50% by weight (weight of 150 g/m²), and the third thermoplastic synthetic fiber 17 was 50% by weight (weight of 150 g/m²). That is, the total weight was set to 300 g/m².

(d) The nonwoven fabric layer 15 was manufactured in a similar way to Example 1. A product made by UNIX Co., Ltd. was selected as the nonwoven fabric layer in Example 2.

(3) The manufacturing method was performed in a similar way to Example 1. In Example 2, the automobile body undercover 36 having a plate thickness of 1.5 to 5.0 mm and a weight of 1500 g/m² was obtained.

### Comparative Example 1

(1) Base Material Layer

The same configuration as in Example 1 was used as the base material layer.

(2) Reinforcing Layer

A polyethylene terephthalate fiber (average fiber length of 64 mm (2.5 inches), average diameter of 3.3 dtex, and weight of 150 g/m²) was selected instead of the nonwoven fabric layer 15 on the side of the road surface B of the base material layer 11 in Example 1. An adhesive film obtained by stacking polyethylene of 30 μm, polyamide resin of 40 μm and polyethylene of 30 μm was pasted between the base material layer 11 and the polyethylene terephthalate fiber layer. A product made by KURABO INDUSTRIES LTD. was selected as the adhesive film in Comparative Example 1.

(3) The stacked body obtained by stacking the base material layer 11, the adhesive film, and the polyethylene terephthalate fiber layer was put in the heating platen press 18 heated up to a temperature of 190° C. to 210° C., and was pressurized, heated and compressed. The stacked body had a thickness of about 10.0 mm in a state where the polypropylene fiber of the base material layer and the polyethylene of the adhesive film were melted at the temperature of about 200° C. The stacked body was pressurized by the cold press 24 and was compressed and molded into a final plate thickness of 1.5 to 5.0 mm, and was cooled at the same time. In this way, in Comparative Example 1, the stacked body having a plate thickness of 1.5 to 5.0 mm and a weight of 1350 g/m² was obtained.

<Sound Absorption Coefficient>

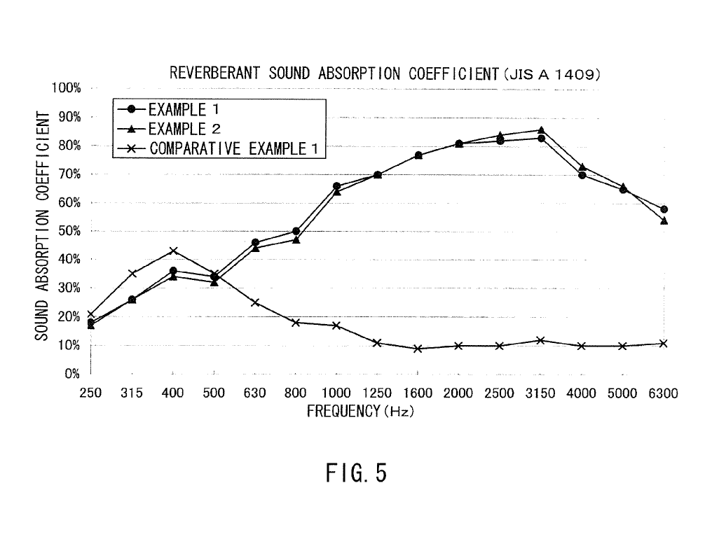

Sound absorption coefficients of Example 1, Example 2 and Comparative Example 1 are shown in FIG. 5. The sound absorption coefficients are based on the JIS A 1409 standard, and are numerical values measured by a reverberant sound absorption coefficient. Specifically, in order to simulate a car-mounted state, the measurement was performed under the condition of a background air layer of 20 mm using a flat plate portion of 5.0 mm.

[Sound Absorption Coefficients of Example 1 and Example 2]

A sound absorption coefficient of at least 30% was measured at a frequency band of 400 to 6300 Hz.

A sound absorption coefficient of at least 40% was measured in a frequency band of 630 to 6300 Hz.

A sound absorption coefficient of at least 60% was measured in a frequency band of 1000 to 5000 Hz.

A sound absorption coefficient of at least 70% was measured in a frequency band of 1250 to 4000 Hz.

A sound absorption coefficient of at least 75% was measured in a frequency band of 1600 to 3150 Hz.

A sound absorption coefficient of at least 80% was measured in a frequency band of 2000 to 3150 Hz.

[Sound Absorption Coefficient of Comparative Example 1]

The sound absorption coefficient of Comparative Example 1 gradually increased up to 250 to 400 Hz. However, the sound absorption coefficient of Comparative Example 1 gradually decreased in a high frequency band of 400 Hz or higher in which a peak in a frequency band of 400 Hz is a boundary.

Specifically, a sound absorption coefficient of at least 20% was measured in a frequency band of 250 Hz.

A sound absorption coefficient of at least 30% was measured in a frequency band of 315 Hz.

A sound absorption coefficient of at least 40% was measured in a frequency band of 400 Hz. The sound absorption coefficient in the frequency band of 400 Hz was a maximum value.

A sound absorption coefficient of at least 30% was measured in a frequency band of 500 Hz.

A sound absorption coefficient of at least 20% was measured in a frequency band of 630 Hz.

A sound absorption coefficient less than 20% was only measured in a frequency band of 800 to 6300 Hz.

Comparative Example 1 has a configuration in which the adhesive film (polyethylene of 30 μm, polyamide resin of 40 μm and polyethylene of 30 μm) is stacked between the base material layer 11 and the polyethylene terephthalate fiber layer. The polyethylene film in the adhesive film is melted. However, the polyamide resin film is not melted and remains. Thus, the polyamide resin film blocks air permeability to reduce the sound absorbing characteristics.

It is obvious that Comparative Example 1 has a high sound absorption coefficient compared with Example 1 and Example 2 in a frequency band of 250 to 500 Hz. However, it is obvious that Comparative Example 1 has a low sound absorption coefficient compared with Example 1 and Example 2 in a frequency band of 630 to 6300 Hz. Particularly, it is obvious that Comparative Example 1 has a sound absorption coefficient of 20% or less whereas Example 1 and Example 2 have a sound absorption coefficient of at least 60%, in a frequency band of 1000 Hz. In the automobile body undercover 36, road noise originating from the side of the road surface B is a main sound absorbing target. Here, the frequency band of the sound of the road noise is about 1000 Hz. Accordingly, it is obvious that Examples 1 and 2 have a configuration suitable for sound absorption of the road noise originating from the side of the road surface B. That is, the automobile body undercover 36 has a configuration in which the entire materials have air permeability and do not form a layer that blocks air permeability, which is considered to be preferable.

<Durability (Chipping Resistance)>

With respect to abrasion of the nonwoven fabric layer 15 of the automobile body undercover 36 due to flying stones or road surface interference, the following results were obtained. With respect to the abrasion due to the flying stones or road surface interference, weight loss due to friction was measured under the condition of 9.81 N and 500 times using an H-18 abrasion wheel by a Taber-type abrasion tester according to the JIS L 1096.8.19 standard, using a flat plate portion of 5.0 mm.

In Example 1, the amount of abrasion loss was 0.08 g. In Example 2, the amount of abrasion loss was 0.12 g. In the amounts of abrasion loss of Examples 1 and 2, only the abrasion of the nonwoven fabric layer 15 occurred.

On the other hand, in Comparative Example 1, the amount of abrasion loss was 0.35 g, in which the abrasion occurred up to the base material layer.

<Separation Strength of Ice Coating>

It is preferable that the automobile body undercover suppresses ice coating, since it has a configuration that covers a lower surface side of the car. Further, it is preferable to use a configuration in which ice coating is easily separated. Thus, in this view, Example 1, Example 2 and Comparative Example 1 were compared with each other under the following conditions with respect to the separation strength of ice coating.

(1) A test piece was 40 mm or more in length and 40 mm or more in width.

(2) A square pipe of 40 mm in length, 40 mm in width and 30 mm in height and 1.6 mm in thickness (JISG3466) was prepared. A hole portion was provided at a central part of a side surface at a position of 5 mm from an end surface of an end of the square pipe.

(3) Under the atmosphere of −15° C., an end surface opposite to the end surface in which the hole portion was formed, among both ends of the square pipe, was disposed to be in contact with the nonwoven fabric layer 15 of the test piece. Then, ice water of 0.5 to 1.0 g at 0° C. to 3° C. was sprayed into the square pipe every 5 minutes using a sprayer to form an icicle of a height of 15 mm in which the nonwoven fabric layer was a bottom surface.

(4) A load cell was mounted to the hole portion of the square pipe, and a separation load when the icicle in the square pipe was separated was measured.

As a result, the separation strength of Example 1 was 43 N. The separation strength of Example 2 was 107 N. On the other hand, the separation strength of Comparative Example 1 was 142 N.

Thus, when Example 1, Example 2 and Comparative Example 1 are compared with each other, it is obvious that it is relatively hard to separate the ice coating, in Comparative Example 1. On the other hand, since Example 1 and Example 2 have low separation strengths compared with Comparative Example 1, it is obvious that it is easy to separate the ice coating.

The automobile body undercover according to the present disclosure is not limited to the present embodiment, and various modifications may be made.

1. An automobile body undercover provided on a lower surface of a car body comprising at least:
a base material layer that includes a mixture of a fiber reinforcing material and a first thermoplastic synthetic resin; and a nonwoven fabric layer of a thermoplastic synthetic fiber that is stacked on a surface that is a road surface side of the base material layer, surface portions of both the layers being bonded by thermal fusion, and both the layers being compression-molded into a predetermined shape to form a fiber molded body,
wherein the first thermoplastic synthetic resin of the base material layer has a melting point for melting in a heating process at the time of molding, and
wherein the nonwoven fabric layer includes a mixture of a second thermoplastic synthetic fiber having a melting point for melting in the heating process at the time of molding and a third thermoplastic synthetic fiber having a melting point for non-melting in the heating process at the time of molding.

2. The automobile body undercover according to claim 1,
wherein the first thermoplastic synthetic resin and the second thermoplastic synthetic fiber are thermoplastic synthetic fibers having the same quality.
